(19) United States
(12) Patent Application Publication
(10) Pub. No.: US 2017/0127150 A1
(43) Pub. Date: May 4, 2017

(54) INTERACTIVE APPLICATIONS IMPLEMENTED IN VIDEO STREAMS

(71) Applicant: Ubitus Inc., Grand Cayman (KY)

(72) Inventors: Jung-Chang Kuo, Taipei City (TW); Sheng Lung Yang, Taipei City (TW); Wei Hao Peng, Taipei City (TW)

(73) Assignee: Ubitus Inc., Grand Cayman (KY)

(21) Appl. No.: 15/095,987

(22) Filed: Apr. 11, 2016

Related U.S. Application Data
(63) Continuation-in-part of application No. 14/932,252, filed on Nov. 4, 2015.

(51) Int. Cl. H04N 21/81; H04N 21/218; H04N 21/858; H04N 21/6587; H04N 21/414; H04N 21/472; H04N 21/235; H04N 21/845

(52) U.S. Cl. CPC H04N 21/8173; H04N 21/2353; H04N 21/2181; H04N 21/8456; H04N 21/812; H04N 21/6587; H04N 21/41407; H04N 21/47202; H04N 21/8586

(57) ABSTRACT

Methods, apparatuses, and computer program products for implementing interactive applications by storing and retrieving streaming video clips and associated metadata are described.

### CROSS-REFERENCE TO RELATED APPLICATIONS

This application is a continuation-in-part of U.S. application Ser. No. 14/932,252, filed on Nov. 4, 2015, which is hereby incorporated by reference in its entirety.

### BACKGROUND

Interactive applications, such as games, can be computationally intensive. Particularly for certain kinds of interactive applications, such as interactive multimedia applications, a major component of this high computational load is the need to generate video and audio in response to user inputs. Further, the load is multiplied by the number of users, since the same video and audio may need to be generated separately for each of the multiple users of a given application.

When such applications are hosted on servers, for example cloud-based servers, one result can be a need for large numbers of servers, which are costly to acquire, update, and maintain.

There is a need for a better solution for hosting computationally intensive interactive applications, such as games.

### SUMMARY

Embodiments of the present invention convert multimedia computer program outputs to a series of streaming video clips that can then be distributed worldwide through the video streaming infrastructure consisting of Internet Data Centers (IDCs) and a Content Delivery Network (CDN).

Further, in some embodiments, the video clips are tagged with metadata to facilitate playback. Metadata can include, for example, an identifier and trigger information. The identifier can be a unique identifier for each video clip. The trigger information can specify the identifier of the next clip to be played, possibly as a function of the current user input or other conditions.

In general, embodiments of the present invention include a video clip production process and an interactive playback process.

In the production process, a user (or, in some variations, a simulated, “robot” user) interacts with a conventional interactive computer program. In response to the user interaction, the computer program produces raw video and sound data. The user input or other event that triggered the production of the particular video and sound data is stored. The particular video and sound data associated with the trigger condition are then converted to streaming video clips. The clips are tagged with metadata, including for example an ID, the trigger condition or playback event, and a length. In some embodiments, the clips are then sent via a Content Delivery Network to selected Internet Data Centers to support one or more interactive applications.

In the playback process, in certain embodiments, for example an embodiment that supports the playing of an interactive game, a first video clip is played. At the conclusion of the playing of the first video clip (or, in some embodiments, at any time during the playing of the first video clip), the metadata is consulted to identify the trigger condition or conditions that will trigger the playing of a next video clip. Upon detection of the trigger condition (for example a user pushing a certain button), the next video clip is played. Playback continues in this manner until a last video clip is played based on a last trigger condition.

In some embodiments, playback occurs in a server, such as a cloud-based streaming server, and the content is streamed to the user from the server. In other embodiments, at playback the content is streamed to the user via the CDN and IDC.

### BRIEF DESCRIPTION OF THE DRAWINGS

FIG. 1 is a block diagram of a distributed client-server computer system supporting interactive real-time multimedia applications according to one embodiment of the present invention.

FIG. 2 is a block diagram of the video streaming infrastructure comprising a Content Delivery Network (CDN) and multiple Internet Data Centers (IDCs), being utilized by embodiments of the present invention to distribute video clips.

FIG. 3 is a diagram depicting the interactive video clip production and playback system according to an embodiment of the present invention.

FIG. 4 is a flow diagram of a video clip production and playback process according to an embodiment of the present invention.

FIG. 5 depicts a graph-structured set of video clips, according to an embodiment of the present invention.

FIG. 6 depicts a system for linking from a linear video to an interactive video script according to an embodiment of the present invention.

FIG. 7 depicts a method for linking from a linear video to an interactive video script according to an embodiment of the present invention.

### DETAILED DESCRIPTION

Embodiments of the present invention provide production and playback of multi-media information as streaming video clips for interactive real-time media applications.

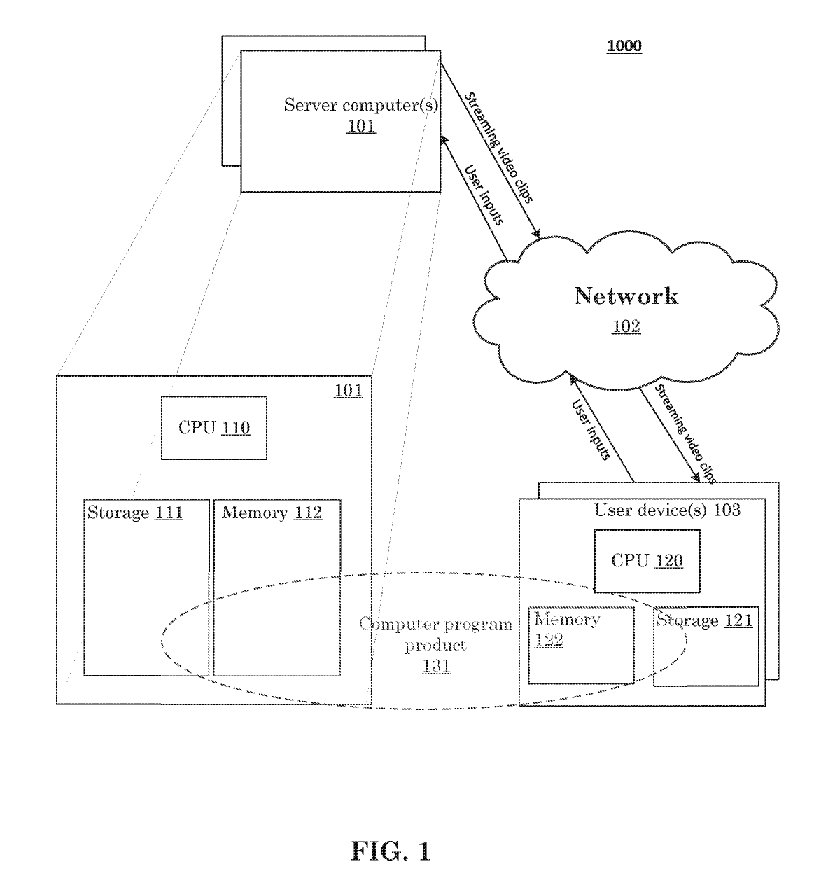

FIG. 1 is a block diagram of a distributed client-server computer system 1000 supporting interactive real-time multimedia applications according to one embodiment of the present invention. Computer system 1000 includes one or more server computers 101 and one or more user devices 103 configured by a computer program product 131. Computer program product 131 may be provided in a transitory or non-transitory computer readable medium; however, in a particular embodiment, it is provided in a non-transitory computer readable medium, e.g., persistent (i.e., non-volatile) storage, volatile memory (e.g., random access memory), or various other well-known non-transitory computer readable mediums.

User device 103 includes central processing unit (CPU) 120, memory 122 and storage 121. User device 103 also includes an input and output (I/O) subsystem (not separately shown in the drawing) (including e.g., a display or a touch enabled display, keyboard, d-pad, a trackball, touchpad, joystick, microphone, and/or other user interface devices and associated controller circuitry and/or software). User device 103 may include any type of electronic device capable of providing media content. Some examples include desktop computers and portable electronic devices such as mobile phones, smartphones, multi-media players, e-readers, tablet/touchpad, notebook, or laptop PCs, smart televisions, smart watches, head mounted displays, and other communication devices.

Server computer 101 includes central processing unit CPU 110, storage 111 and memory 112 (and may include an I/O subsystem not separately shown). Server computer 101 may be any computing device capable of hosting computer product 131 for communicating with one or more client computers such as, for example, user device 103, over a network such as, for example, network 102 (e.g., the Internet). Server computer 101 communicates with one or more client computers via the Internet and may employ protocols such as the Internet protocol suite (TCP/IP), Hypertext Transfer Protocol (HTTP) or HTTPS, instant-messaging protocols, or other protocols.

Memory 112 and 122 may include any known computer memory device. Storage 111 and 121 may include any known computer storage device.

Although not illustrated, memory 112 and 122 and/or storage 111 and 121 may also include any data storage equipment accessible by the server computer 101 and user device 103, respectively, such as any memory that is removable or portable, (e.g., flash memory or external hard disk drives), or any data storage hosted by a third party (e.g., cloud storage), and is not limited thereto.

User device(s) 103 and server computer(s) 101 access and communicate via the network 102. Network 102 includes a wired or wireless connection, including Wide Area Networks (WANs) and cellular networks or any other type of computer network used for communication between devices.

In the illustrated embodiment, computer program product 131 in fact represents computer program products or computer program product portions configured for execution on, respectively, server 101 and user device 103. A portion of computer program product 131 that is loaded into memory 112 configures server 101 to record and play back interactive streaming video clips in conformance with the inventive requirements further described herein. The streaming video clips are played back to, for example, user device 103, which supports receiving streaming video, such as via a browser with HTML5 capabilities.

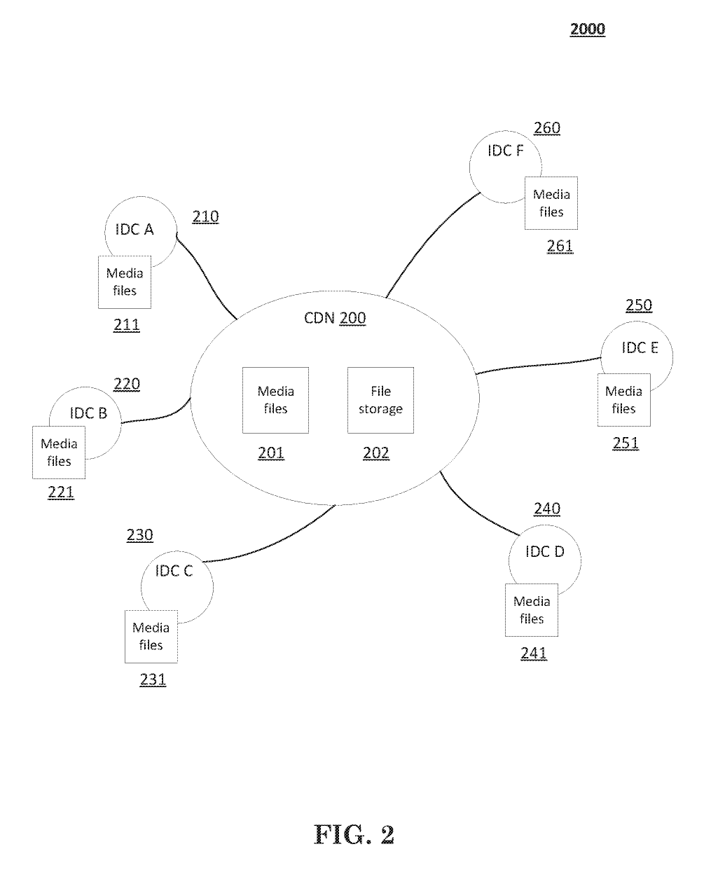

FIG. 2 illustrates an example of the video streaming infrastructure 2000, being utilized by some embodiments of the present invention to distribute video clips. As shown, video streaming infrastructure 2000 comprises Content Delivery Network (CDN) 200 and Internet Data Centers (IDCs) 210-260.

Media files 201 are initially stored in file storage 202. Media files 201 are then distributed via CDN 200 to IDCs 210-260. After a file is distributed, each respective IDC has a local copy of the distributed media file. The respective local copies are then stored as media file copies 211-261. Each IDC 210-260 then serves streaming media, such as video, to users in the geographic vicinity of the respective IDC, in response to user requests. Media file copies 211-261 may be periodically updated.

In some embodiments of the present invention, video streaming infrastructure 2000 is used to distribute the video clips produced by the inventive process disclosed herein. That is, for example, the inventive video clips are stored as media files 201 in file storage 202, and then distributed via CDN 200 to IDCs 210-260, where they are available for playback to users as streaming video.

In other embodiments, the inventive video clips are distributed directly from, for example, a server or servers, such as cloud-based servers, without making use of video streaming infrastructure 2000.

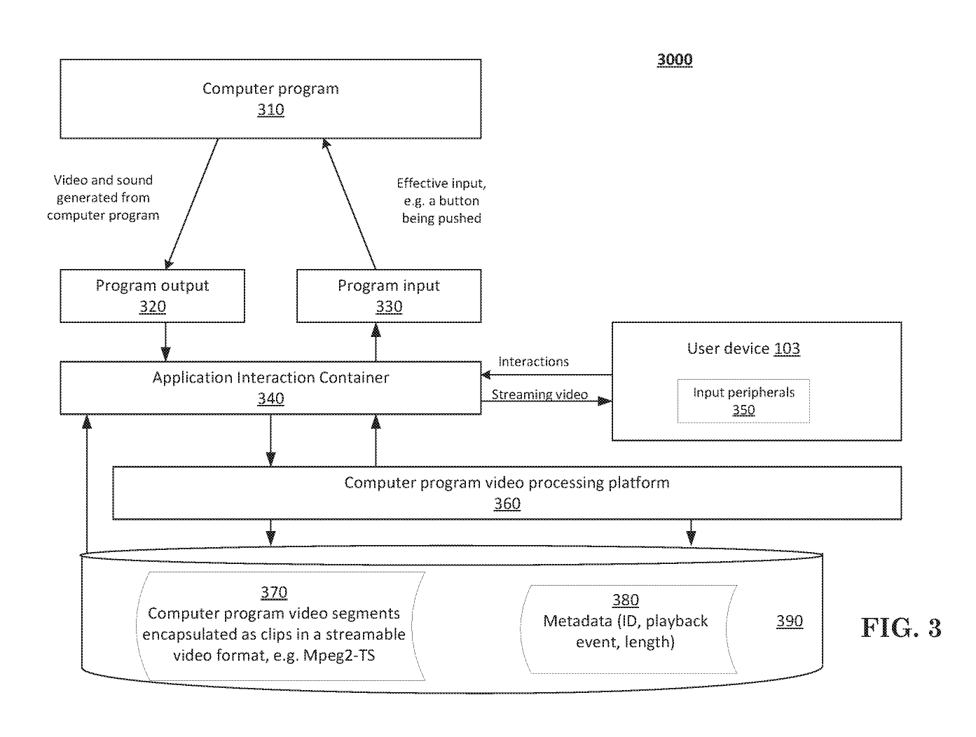

FIG. 3 is a high-level block diagram of a system 3000 for producing and storing interactive video clips tagged with metadata, and for delivering interactive video to a user device, according to embodiments of the present invention. System 3000 may be realized as hardware modules, or software modules, or a combination of hardware and software modules. In some embodiments, at least part of system 3000 comprises software running on a server, such as server 101.

In the illustrated embodiment, in addition to producing and storing interactive video clips tagged with metadata, system 3000 performs additional related functions. For example, in this embodiment system 3000 is also capable of playing back prestored video clips and is additionally capable of streaming video to a user in response to user interactions without first storing the video as a video clip. In alternative embodiments, one or more of these functions can be provided by a separate system or systems.

In FIG. 3, computer program 310 can be, for example, an interactive multimedia application program. For example, computer program 310 can be a gaming application program. Computer program 310 produces program output 320 in response to program input 330.

In some embodiments, program output 320 comprises raw video and sound outputs. In some embodiments, program output 320 comprises a video rendering result.

In some embodiments, program input 330 comprises control messages based on indications of user input interactions, such as a user pushing a button, selecting an item on a list, or typing a command. Such user input interactions can originate from input peripherals 350, which can be peripherals associated with a user device, such as user device 103. Specific user device-associated peripherals can include a joystick, a mouse, a touch-sensitive screen, etc. In some embodiments, input peripherals 350 can be collocated with a remote user device 103 and communicate with other elements of the system via a network. Although labeled as “peripherals,” those skilled in the art will understand that input devices/elements such as peripherals 350 may, in particular embodiments, include input elements that are built into, i.e., part of, user device 103 (e.g., a touchscreen, a button, etc.) rather than being separate from and plugged into, user device 103.

In some embodiments, input peripherals 350 are “robot” entities that produce sequences of inputs that simulate the actions of a real user. Such robot entities can be used to “exercise” the system and cause it to produce many (or even all) possible instances of program output 320. The purpose of “exercising” system 3000 in this manner may be to, for example, cause it to produce and store at least one copy of each video clip associated with program output 320.

Application Interaction Container 340 provides a runtime environment to run computer program 310. In embodiments of the present invention, Application Interaction Container 340 detects and intercepts user inputs generated by input peripherals 350 and delivers the intercepted user inputs to computer program 310 in the form of program input 330.

Application Interaction Container 340 also intercepts raw video and sound generated as program output 320 and, utilizing the services of computer program video processing platform, 360, converts the raw video and sound to a streaming video format, and then stores the converted video and sound as one or more video segments or clips 370 in database 390. Each clip represents the audio and video program output produced in response to particular trigger conditions (or playback events), where the set of possible trigger conditions comprise, for example, particular items of program input 330. In some embodiments, the raw video and sound are converted into a multi-media container format. In some embodiments, the raw video and sound are converted into the format known as MPEG2-Transport Stream (MPEG2-TS).

As the video clips 370 are generated, they are also tagged with a set of attributes 380 (also referred to herein as “metadata”), comprising, for example, a clip ID, a playback event, and a length. The attributes in metadata 380 are stored in association with corresponding video clips 370 in database 390. The stored clips 370 can then be used for future playback. The stored, tagged video clips 370 can be re-used by the same user or a different user. Potentially, a given clip 370 can be reused by thousands of users interacting with computer program 310 on a shared server or set of servers.

For example, the next time a given playback event arises (based, for example, on the detection of a particular user input, either from the same user or a different user), the stored video clip 370 tagged with that event can be played, thus avoiding the need to regenerate the corresponding raw video and sound. For some applications, this can result in a substantial savings of computer processing power. See description of playback process below for further details.

As noted above, in the illustrated embodiment, system 3000 can also play back prestored video clips. For example, based on a user interaction via input peripherals 350 resulting in program input 330, computer program 310 may determine that a certain prestored clip 370 with metadata 380 corresponding to the user interaction is available and is the appropriate response to the user interaction. The matching clip 370 can then be retrieved from storage and streamed, for example according to a multi-media container format, such as MPEG2-TS, to user device 103.

As further noted above, in the illustrated embodiment, system 3000 can also stream video to a user in response to user interactions even if the video is not currently stored as a streaming video clip 370. For example, based on a user interaction via input peripherals 350 resulting in program input 330, computer program 310 may determine that a certain video output is the appropriate response to the user interaction, but that no corresponding clip 370 is available. The required video can then be generated by computer program 310 as raw video output 320. Application Interaction Container 340 then intercepts the program output 320 and, utilizing the services of computer program video processing platform 360, converts the raw video to a streaming format, according to, for example, a multi-media container format, such as MPEG2-TS, and sends the streaming video to user device 103. Advantageously, the streaming video can simultaneously be recorded, encapsulated as a video clip 370, and stored for future use along with appropriate metadata 380.

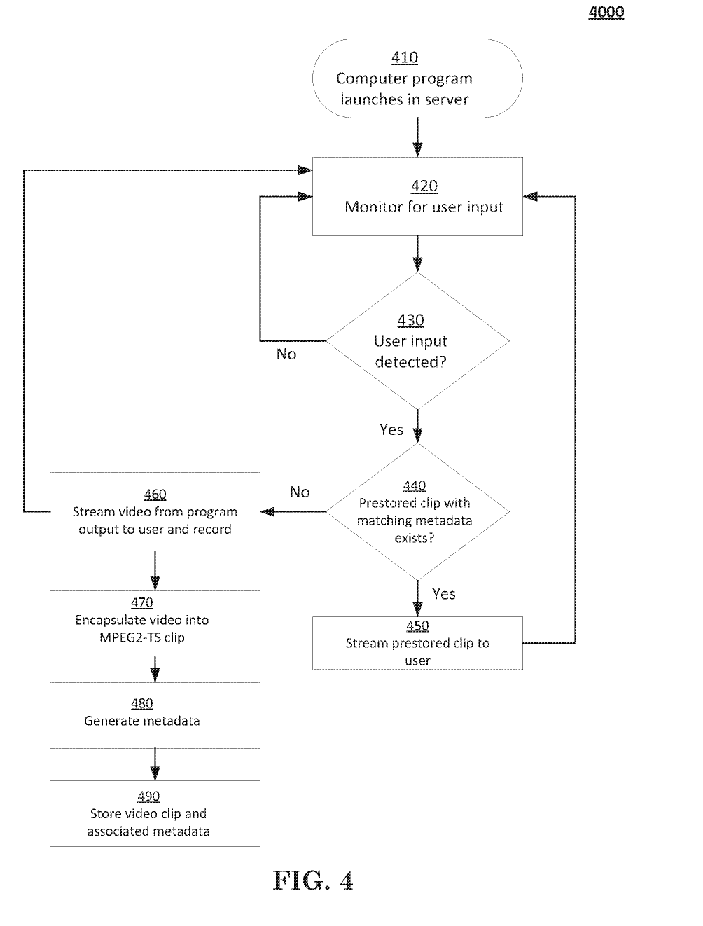

FIG. 4. illustrates a process 4000 for producing, storing, and playing interactive video clips and related metadata, according to embodiments of the present invention. In some embodiments, process 4000 can also support other related functions, such as, for example, streaming video to a user without first storing the video as a video clip.

At step 410, a computer program launches in a server, such as server 101. The server can be, for example, a cloud-based server. The server can be, for example, a game server. The computer program can be, for example, an interactive multimedia application program, such as, for example, a game application.

At step 420, the process monitors for user input.

At decision box 430, if no user input is detected, the process returns to step 420 and continues to monitor for user input. If user input is detected, control passes to decision box 440.

At decision box 440, if a prestored video clip with matching metadata (i.e., metadata corresponding to the user input) exists, control passes to step 450, where the prestored video clip is streamed to the user. Control then returns to step 420 and the process continues monitoring for user input.

If, at decision box 440, no prestored clip with matching metadata is found, control passes to step 460. At step 460, a video segment from the program output responsive to the user input is streamed to the user. Simultaneously, the video segment is recorded in preparation for the creation of a corresponding video clip. At step 470, the recorded video is encapsulated into a video clip in a streaming format. For example, the streaming format can be a multi-media container format such as MPEG2-TS.

At step 480, metadata associated with the video clip (e.g. clip ID, playback event or trigger, length) is generated.

At step 490, the video clip and its associated metadata are stored for future use. For example, the video clip can be used in the future by a playback process when a trigger corresponding to the stored metadata for the clip is encountered. By using the stored video clip, the playback process can then avoid the need for the computer program to regenerate the video segment corresponding to the stored video clip.

Video segments can continue to be recorded, encapsulated into clips in a streaming format, and stored with associated metadata until, for example, the game ends.

Note that, in the case where process 4000 is running on a server, for example a cloud-based server, it may actually be handling multiple users, possibly many users, simultaneously. In such a case, it is entirely possible that a given video segment has already been recorded, encapsulated and stored as a video clip 370, with corresponding metadata 380 in the course of a previous user's interaction with process 4000. In such a case, it should not be necessary to record the corresponding segment again. Rather, the video clip can be retrieved from the set of previously stored clips, based on the metadata, which can include a unique ID.

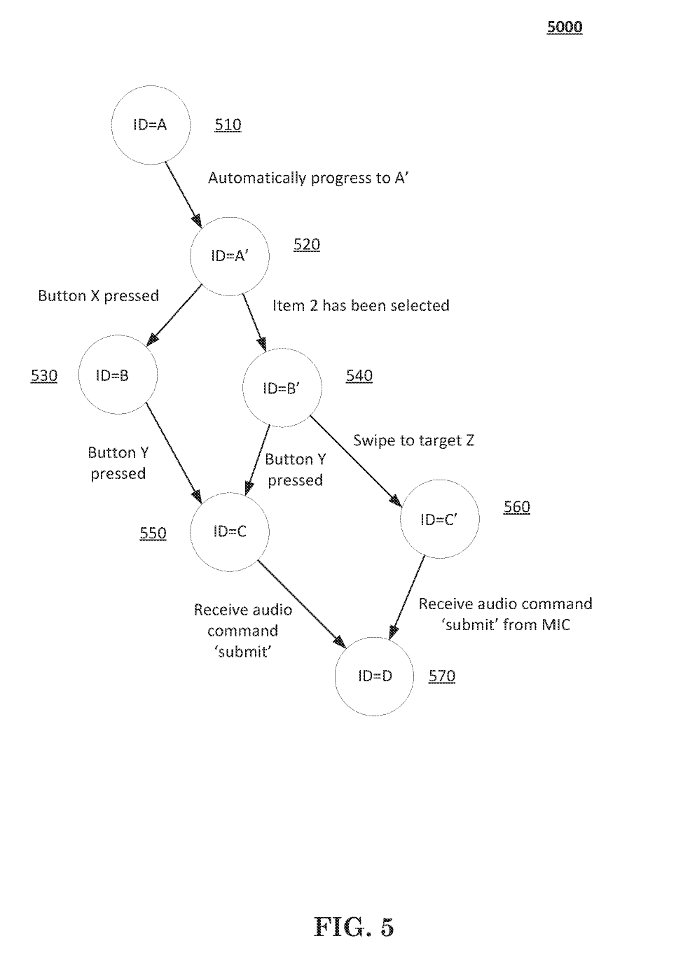

FIG. 5 displays an example graph-structured set 5000 of video clips and associated metadata, used in a playback process according to embodiments of the present invention. These clips may be, for example, video clips 370 and associated metadata 380 produced by the system 3000 of FIG. 3 and/or by the process 4000 of FIG. 4. In a playback process, video clips 370 are streamed from a server, such as server computer 101 or a server associated with an Internet Data Center, such as IDC 210. Video clips 370 are received and viewed at a user device, such as user device 103, which is equipped with suitable capabilities, such as a browser supporting HTML5.

Each interactive multimedia application or portion of an application may have associated with it a playback video clip set of a form similar to video clip set 5000, also referred to as a “metadata playlist.” For example, each level of a multilevel game can have its own metadata playlist. As described above, the metadata associated with each video clip 370 is learned as the application executes in response to real or “robot” user input. Therefore, at the same time, the metadata playlist 5000 is also learned. This is because the metadata playlist is the collection of video clips 370, linked according to metadata 380, for the particular application or portion of an application.

In the example of FIG. 5, the video clips are represented by circles, each having an ID. For example, video clip 510 is labeled with ID=A. Arrows represent “playback events” or trigger conditions that cause the playback process 5000 to progress in the direction of the arrow. For example, if video clip 520 is playing and Button X is pushed, the playing of video clip 520 stops and video clip 530 starts. If, on the other hand, the user selects “item 2” while video clip 520 is playing, the process transitions instead to video clip 540. If video clip 530 is playing and button Y is pressed, the process transitions to and plays video clip 550. Also, if video clip 540 is playing and button Y is pressed, the process transitions to and plays video clip 550. If video clip 540 is playing and the user swipes to “target Z,” then the process transitions to and begins playing video clip 560. If either of video clip 560 or 550 is playing and the audio command “submit” is received from the microphone (“MIC”), the process transitions to and begins playing video clip 570. Illustrating a somewhat different kind of trigger, when video clip 510 is finished playing, the process automatically progresses to the video clip labeled A′, namely video clip 520.

Optionally, a caching mechanism can be employed to help smooth playback of the video clips.

In some embodiments of the present invention, the video delivered from a server to a user device is a mix of pre-calculated video (stored and re-played video clips) and real-time generated video streams (for video that has not yet been stored as video clips with metadata).

In the above description, reference is made to streaming multi-media container formats, such as MPEG2-TS. It should be understood that embodiments of the present invention are not limited to MPEG2-TS, but rather can employ any of a wide variety of streaming container formats, including but not limited to 3GP, ASF, AVI, DVR-MS, Flash Video (FLV, F4V), IFF, Matroska (MKV), MJ2, QuickTime File Format, MPEG program stream, MP4, Ogg, and RM (RealMedia container). Embodiments that operate without a standardized container format are also contemplated.

Linking to an Interactive Video Script from a Linear Video

A metadata playlist such as metadata playlist 5000 can also be referred to as representing an “interactive video script.” That is, the metadata playlist 5000 represents determining, as a function of user input, the direction that a video “script” will take. Thus, in the example of FIG. 5, at step 520, if item 2 is selected the video script continues with the contents of video clip ID=B′, whereas if button X is pressed, the video script continues with the contents of video clip ID=B. This is in contrast to a conventional “linear” video (or “linear playback” video). A “linear video” or “linear playback video” is defined herein as a conventional video that just plays from start to finish, possibly subject to a typical media player's user controls such as a fast-forward or rewind capability to move back and forth in the same linear video.

It may sometimes be desirable to utilize a combination of a linear playback video and an interactive video script. For example, it may be desirable to link to an interactive video script from a linear video or to switch between (possibly to switch back and forth between) a linear playback video and an interactive video script. Also, in some cases it may be desirable to link from a linear video to a particular location in an interactive video script, for example in order to play a particular portion of the interactive video script.

As one example, consider an advertisement for a set of games offered through a cloud gaming service. Playing of the advertisement may be initiated by a user clicking on a link to a video ad for the service on a web site. The video ad then begins playing as a conventional linear playback video. However, at one or more points in the linear video, the user is invited to experience playing an actual game. The user then performs a triggering action that initiates play of the game via an interactive video script. Depending on, for example, the triggering action, play can be initiated from the beginning of the interactive video script, or from some other location within the interactive video script. Referring again to FIG. 5, play might start at 510 with the playing of video clip ID=A, but alternatively might start at 530 with the playing of video clip ID=B. At the conclusion of the game (or upon further specific user input) the interactive script terminates. Optionally, linear video playback can resume after the video script terminates.

In the above scenario, an important challenge is to identify the specific game (or portion of a game, or location within a game) that is to be initiated based on the user input triggering action. One solution to this problem is to provide a current play timestamp that is sent with the user interaction trigger. The timestamp identifies the portion of the linear video that was being viewed at the time of the user interaction. The desired game (or portion of a game, or location within a game) is then identified as the one that was being featured at that time in the linear video playback.

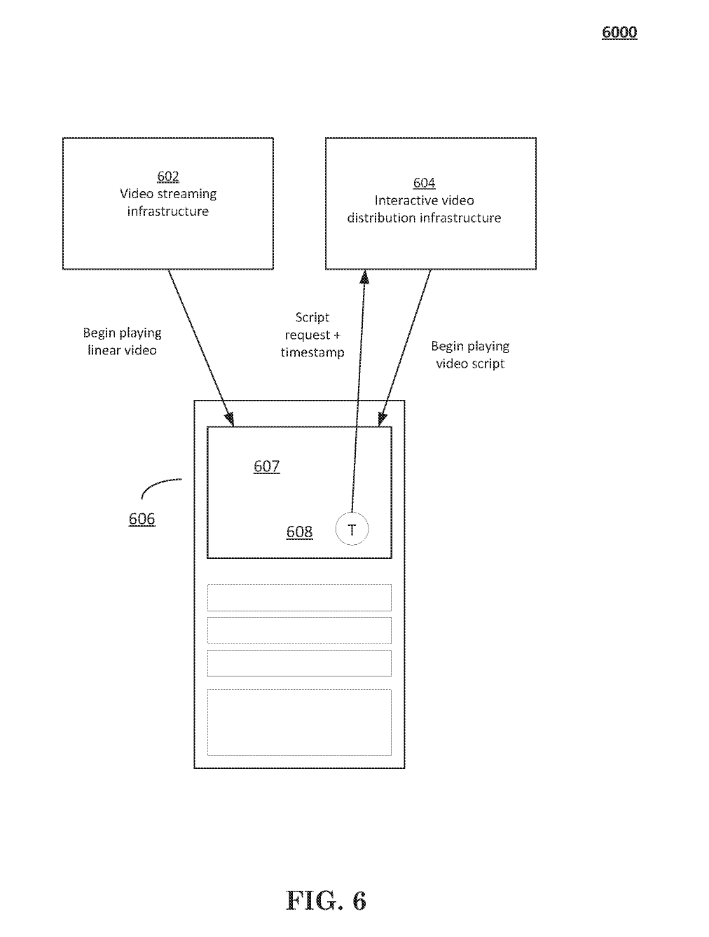

FIG. 6 displays an example system for linking to an interactive video script from a linear video according to some embodiments of the present invention. In the system of FIG. 6, for example, a user operating user device 606 could initiate playing of a linear video, for example by clicking a link on a web page displayed on screen 607. User device 606 could be, for example, a laptop computer, tablet, or smartphone. In some embodiments, the linear video may be supplied via video streaming infrastructure 602. Video streaming infrastructure 602 might correspond, for example, to video streaming infrastructure 2000, comprising CDN 200 and Internet Data Centers 210-260, as shown in FIG. 2.

At any time during the linear video playback, the user can trigger the playing of an interactive video script. Optionally, the user can trigger the playing of the interactive video script starting with any location within the script. Any of a variety of user actions might be used as a trigger mechanism, including for example selecting a menu item, clicking a link, pressing a physical button, or speaking a voice command. As one example, the user might trigger the playing of an interactive video script by touching a screen location 608 (labeled “T” for trigger in the figure). Touching screen location 608 during linear video playback would then trigger the sending of a script request. In some embodiments, the script request comprises a timestamp.

The purpose of the timestamp is to identify the particular video script being requested based on the amount of time that has elapsed since the linear video began playing. For example, in the advertising scenario described above, a request at T1 seconds might identify a script corresponding to multimedia interactive game G1, because the linear ad is presenting the features of that game at time T1. In other embodiments, the particular video script is identified by another mechanism. In some embodiments, the particular video script is identified by clicking on a menu item. In some embodiments, the particular video script is identified by pressing a physical button, or via a voice command. In some embodiments, the timestamp or other mechanism is used to identify not only a particular video script, but also a particular starting location within the video script.

Once the particular script is identified from the timestamp, play of the game corresponding to the selected script can commence. Play will be carried out according to a process such as that described above, for example in connection with FIG. 5. That is, video clips corresponding to the game will be played in an order determined by stored metadata and current user interactions. While the example of a game has been described, it will be appreciated that other forms of interactive content can be delivered in a similar manner.

In FIG. 6, the interactive video script is shown being delivered over interactive video distribution infrastructure 604. As discussed above in connection with FIG. 2, it may be possible and desirable to deliver video clips over existing video streaming infrastructure 2000. In such scenarios, both video streaming infrastructure 602 and interactive video distribution infrastructure 604 correspond to existing video streaming infrastructure 2000. In other embodiments, video clips corresponding to the selected interactive video script are streamed directly to user device 606 over a network, such as the Internet, without making use of a video streaming infrastructure or interactive video distribution infrastructure.

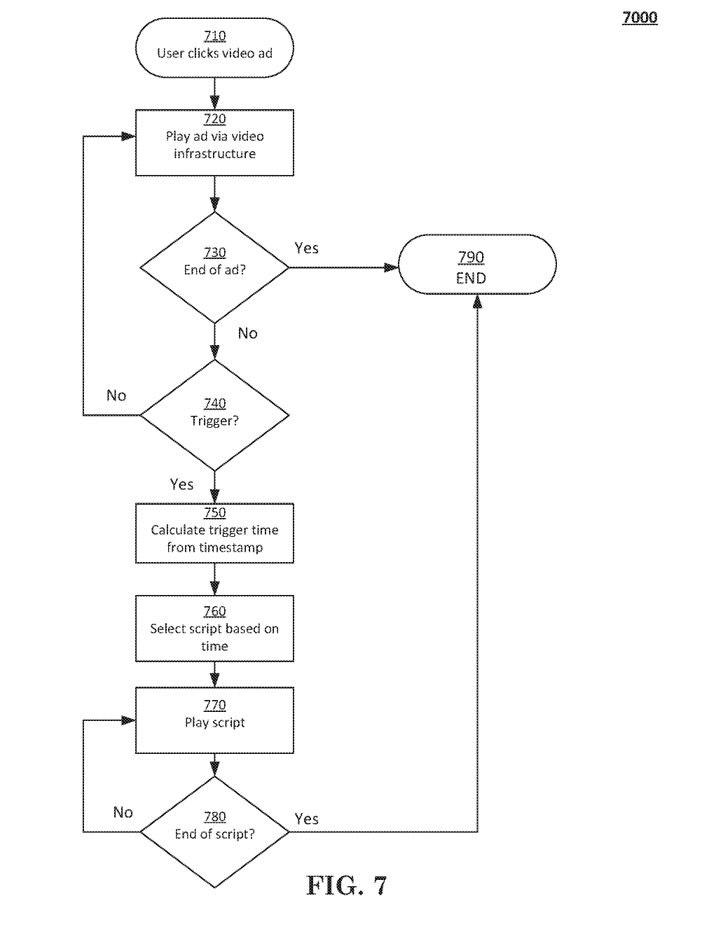

FIG. 7 is a flow diagram depicting an exemplary process for linking to an interactive video script from a linear video, for example a video advertisement.

At step 710, a user clicks a link on a web page corresponding to a linear video ad. At step 720, the linear video ad plays via a video streaming infrastructure. At decision box 730, if the linear video ad has reached the end, control transfers to box 790 and the process ends. If the end has not been reached and playback continues, at decision box 740 the system monitors for triggers. If no trigger is detected, linear playback continues.

If a trigger is detected, at step 750 the playback time of the video at the time of the trigger action is calculated from a timestamp sent with the trigger. At step 760 a particular interactive video script is selected based on the calculated playback time. As discussed above, other mechanisms may alternatively be employed to select a particular interactive video script. Also, as discussed above, the timestamp or other mechanism may optionally be used to identify a particular starting location within the particular interactive video script.

At step 770 the selected interactive video script is played. Playback of the interactive video script can proceed, for example, generally in the manner of metadata playlist embodiments discussed in connection with FIG. 5 above. At decision box 780, if the end of the script has not been reached, play continues. If the end of the script has been reached, control transfers to box 790 and the process ends.

Although, in the embodiment of FIG. 7, the process terminates when the end of the interactive video script is reached, other embodiments are contemplated in which viewing of the linear video can continue after the conclusion of the interactive video script. Still other embodiments are contemplated in which the user can switch between viewing a linear video and an interactive video script an arbitrary number of times. Additional embodiments are contemplated in which a user can switch between viewing any of a plurality of linear videos and any of a second plurality of interactive video scripts.

Although a few exemplary embodiments have been described above, one skilled in the art will understand that many modifications and variations are possible without departing from the spirit and scope of the present invention. Accordingly, all such modifications and variations are intended to be included within the scope of the claimed invention.

1. A method for playing an interactive video script comprising:
initiating playback of a linear playback video in response to a first user request;
receiving a second user request comprising a timestamp associated with a time location in the linear playback video;
selecting, based on the timestamp, a particular location in a particular interactive video script, the particular interactive video script comprising a set of prerecorded streaming video clips stored with corresponding metadata, wherein the prerecorded streaming video clips are recorded prior to initiating playback of the linear video in response to the first user request; and
playing the particular interactive video script, from the particular location, including responding to any further user input based on the metadata.

2. The method of claim 1, further comprising returning to playback of the linear playback video.

3. The method of claim 2, wherein returning to playback of the linear playback video is triggered by the ending of the interactive video script.

4. The method of claim 2, wherein returning to playback of the linear playback video is triggered by a third user request.

5. The method of claim 1, wherein the streaming video clips are formatted according to a multi-media container format.

6. The method of claim 1, wherein the linear playback video is delivered via a video streaming infrastructure.

7. The method of claim 1, wherein the interactive video script is delivered via a video streaming infrastructure.

8. The method of claim 1, wherein the particular interactive video script is selected from multiple interactive video scripts.

9. The method of claim 1, wherein the particular location is a start point.

10. A method for playing an interactive video script comprising:
initiating playback of a linear playback video in response to a first user request;
receiving a second user request comprising a user interaction with the linear playback video;
using a characteristic of the user interaction to select a particular location in an interactive video script, comprising prerecorded streaming video clips that were recorded prior to initiating playback of the linear playback video;
playing the particular interactive video script from the particular location, including responding to any further user input based on prestored metadata; and
returning to the linear playback video at the conclusion of the interactive video script.

11. The method of claim 10, wherein the second user request comprises clicking a link used to select the particular location in the interactive video script.

12. The method of claim 10, wherein the second user request comprises a voice command used to select the particular location in the interactive video script.

13. The method of claim 10, wherein the second user request comprises a physical button push used to select the particular location in the interactive video script.

14. The method of claim 10, wherein the second user request comprises a timestamp used to select the particular location in the interactive video script based on the amount of time that has elapsed since the linear playback video began playing.

15. The method of claim 10, wherein the first user request comprises clicking on a link representing a video advertisement.

16. A system for alternating play of one or more linear videos and one or more interactive video scripts, comprising a user device, a video streaming infrastructure, and an interactive video script player, wherein
the user device is configured to receive and display the playback of a linear video, accept a user request for playback of an interactive video script and transmit the user request along with a corresponding timestamp to the interactive video script player;
the interactive video script player is configured to select and play a particular interactive video script comprising streaming video clips recorded prior to playback of the linear video, from a particular location in the interactive video script based on the timestamp; and
the video streaming infrastructure is configured to deliver at least one of the linear video and the interactive video script to the user device.

17. The system of claim 16 wherein the user device is configured to resume playing the linear video when the interactive video script has concluded.

18. The system of claim 17 wherein the user device is configured to accept a second user request for playback of a second interactive video script and to transmit the second user request along with a second timestamp to the interactive video script player.

19. The system of claim 18 wherein the interactive video script player is configured to select and play a second particular interactive video script based on the second timestamp.

20. The system of claim 16 wherein the interactive video script player comprises a set of prerecorded streaming video clips stored in a database along with corresponding metadata.

21. The system of claim 16, wherein the user device is a smartphone comprising a touch screen.

22. A computer program product in a non-transitory computer-readable medium comprising instructions executable by a computer processor to:
initiate playback of a linear playback video in response to a first user request;
receive a second user request comprising a timestamp;
select, based on the timestamp, a particular location in a particular interactive video script, the interactive video script comprising streaming video clips that were recorded prior to initiation of playback of the linear playback video; and
play the particular interactive video script from the particular location, including responding to any further user input based on prestored metadata.
